(19) United States
(12) Patent Application Publication
(10) Pub. No.: US 2017/0291574 A1
(43) Pub. Date: Oct. 12, 2017

(54) PRETENSIONER, SEAT BELT RETRACTOR, AND SEAT BELT APPARATUS PROVIDED WITH THE SEAT BELT RETRACTOR

(71) Applicant: TAKATA CORPORATION, Tokyo (JP)

(72) Inventors: Hideyuki SUZUKI, Shiga (JP); Yusuke IURA, Shiga (JP); Masahiro SHIOTANI, Shiga (JP)

(73) Assignee: TAKATA CORPORATION, Tokyo (JP)

(21) Appl. No.: 15/511,995

(22) PCT Filed: Sep. 1, 2015
(86) PCT No.: PCT/JP2015/074830

§ 371 Date: Mar. 16, 2017

(30) Foreign Application Priority Data
Oct. 3, 2014 (JP) 2014-204528

(51) Int. Cl. B60R 22/46

(52) U.S. Cl. CPC B60R 22/4671; B60R 22/4676; B60R 2022/4685

(57) ABSTRACT

Provided is a pretensioner that can be easily and accurately assembled and manufactured, a seat belt retractor, and a seat belt apparatus provided with the seat belt retractor. A pretensioner has at least a gas generator for generating gas in the event of an emergency, a case, a pipe mounted to the case, a predetermined number of drive transmission members that are movably provided in the pipe and moved by receiving gas pressure to transmit force for rotating the spool in the seat-belt retracting direction, a piston that is movably provided in the pipe and moved by receiving gas pressure to push the drive transmission members, a ring gear that is at least rotatably provided in the case, has, on the outer periphery thereof, a plurality of pressed portions pressed by the drive transmission members, and rotates the spool by the pressing force, and an elastic member attached to the gas generator side of the piston.

### TECHNICAL FIELD

The present invention relates to a technical field of a seat belt retractor provided with a pretensioner and an energy absorbing (EA) mechanism and a technical field of a vehicle seat belt apparatus.

### BACKGROUND ART

Various types of seat belt retractors provided with a pretensioner are developed for a seat belt apparatus mounted in a vehicle such as an automobile. In an initial stage of an emergency, such as a vehicle collision, when a deceleration higher than the normal deceleration is applied to the vehicle, a pretensioner rotates a spool of a seat belt retractor in a seat-belt retracting direction by using reaction gas generated by a gas generator, thereby winding a seat belt around the spool. This quickly removes slack from the seat belt and applies tension to the seat belt so as to increase the occupant restraint force.

As an example of a conventional pretensioner, there is known a pretensioner in which a plurality of balls serving as force transmission members and a piston are stored in a pipe. The piston pushes these balls by receiving gas pressure of reaction gas generated by a gas generator in the event of an emergency, and thereby moves the balls along the interior of the pipe so as to press a plurality of pressed portions of a ring gear. When the ring gear is rotated by the press of the balls, a spool rotates in a seat-belt retracting direction to retract the seat belt (for example, see Patent Document 1).

In the pretensioner described in Patent Document 1, a spring is provided between the piston and balls so as to prevent backlash between the balls and between balls and the piston even when a gap is generated between the balls.

### CITATION LIST

### Patent Document

Patent Document 1: JP 2014-80121A

### DISCLOSURE OF THE INVENTION

### Problems to be Solved by the Invention

However, in a conventional pretensioner, the piston and the spring are separately installed in assembly, so that the spring may be moved out of the pipe by its own biasing force before installation of the gas generator. In such a case, the spring needs to be put back in the pipe, which may adversely affect a manufacturing process.

The present invention has been made in view of such a situation, and the object thereof is to provide a pretensioner that can be easily and accurately assembled and manufactured, a seat belt retractor, and a seat belt apparatus provided with the seat belt retractor.

### Means for Solving the Problems

To solve the above problem, a pretensioner according to the present invention includes: a gas generator that generates gas in the event of an emergency; a case; a pipe mounted to the case; a predetermined number of drive transmission members that are movably provided in the pipe and moved by receiving a pressure of the gas to transmit force for rotating a spool in a seat-belt retracting direction; a piston that is movably provided in the pipe and moved by receiving a pressure of the gas to push the drive transmission members; a ring gear that is at least rotatably provided in the case, has, on the outer periphery thereof, a plurality of pressed portions pressed by the drive transmission members, and rotates the spool by the pressing force; and an elastic member attached to the gas generator side of the piston.

In the pretensioner according to the present invention, the piston has a piston body and a piston ring fitted to the piston body, the piston body has a shaft portion formed at the gas generator side thereof, and the elastic member is attached to the shaft portion.

In the pretensioner according to the present invention, the piston body has an exhaust passage penetrating the piston body from the drive transmission member side to the gas generator side.

In the pretensioner according to the present invention, the shaft portion has a projection on which the elastic member is hooked.

In the pretensioner according to the present invention, the piston has a hooking member on which the elastic member is hooked, and the hooking member has a tubular portion fitted to the shaft portion and a flange portion at least a part of which protrudes from one end of the tubular portion.

A seat belt retractor according to the present invention includes: a seat belt; a spool that retracts the seat belt; a locking member that is rotated together with the spool in a normal state and inhibited from being rotated in a seat-belt withdrawing direction in the event of an emergency so as to produce relative rotation with respect to the spool; a lock mechanism that locks the rotation of the locking member in the seat-belt withdrawing direction in the event of the emergency; an energy absorption mechanism that is provided between the spool and the locking member and limits a load applied to the seat belt during the relative rotation between the spool and the locking member; and the pretensioner that operates in the event of the emergency so as to rotate the spool in the seat-belt retracting direction.

A seat belt apparatus according to the present invention includes: the seat belt retractor that retracts the seat belt; a tongue slidably supported by the seat belt withdrawn from the seat belt retractor; and a buckle by which the tongue is disengageably retained. In the event of an emergency, the withdrawal of the seat belt is inhibited by the seat belt retractor to restrain an occupant.

### Advantages of the Invention

According to the present invention, a pretensioner includes: a gas generator that generates gas in the event of an emergency; a case; a pipe mounted to the case; a predetermined number of drive transmission members that are movably provided in the pipe and moved by receiving a pressure of the gas to transmit force for rotating a spool in a seat-belt retracting direction; a piston that is movably provided in the pipe and moved by receiving a pressure of the gas to push the drive transmission members; a ring gear that is at least rotatably provided in the case, has, on the outer periphery thereof, a plurality of pressed portions pressed by the drive transmission members; and an elastic member attached to the gas generator side of the piston. Thus, the spool is rotated by the pressing force of the elastic member, so that the piston and elastic member can be integrally handled at assembly, allowing easy and accurate assembling and manufacturing to be achieved.

According to the pretensioner of the present invention, the piston has a piston body and a piston ring fitted to the piston body, the piston body has a shaft portion formed at the gas generator side thereof, and the elastic member is attached to the shaft portion. With this configuration, it is possible to achieve more easy and accurate assembling and manufacturing, which in turn achieves accurate operation.

According to the pretensioner of the present invention, the piston body has an exhaust passage penetrating the piston body from the drive transmission member side to the gas generator side. With this configuration, gas in the pipe at the gas generator side can flow to the balls side of the piston, allowing further smooth movement of the piston.

According to the pretensioner of the present invention, the shaft portion has a projection on which the elastic member is hooked. With this configuration, the elastic member can be hooked on the projection, allowing more easy and accurate assembling and manufacturing to be achieved.

According to the pretensioner of the present invention, the piston has a hooking member on which the elastic member is hooked, and the hooking member has a tubular portion fitted to the shaft portion and a flange portion at least a part of which protrudes from one end of the tubular portion. With this configuration, the elastic member can be hooked on the hooking member, allowing more easy and accurate assembling and manufacturing to be achieved.

According to the present invention, a seat belt retractor includes: a seat belt; a spool that retracts the seat belt; a locking member that is rotated together with the spool in a normal state and inhibited from being rotated in a seat-belt withdrawing direction in the event of an emergency so as to produce relative rotation with respect to the spool; a lock mechanism that locks the rotation of the locking member in the seat-belt withdrawing direction in the event of the emergency; an energy absorption mechanism that is provided between the spool and the locking member and limits a load applied to the seat belt during the relative rotation between the spool and the locking member; and the pretensioner that operates in the event of the emergency so as to rotate the spool in the seat-belt retracting direction. With this configuration, the piston and elastic member of the pretensioner can be integrally handled at assembly, allowing more easy and accurate assembling and manufacturing to be achieved.

According to the present invention, a seat belt apparatus includes: the seat belt retractor that retracts the seat belt; a tongue slidably supported by the seat belt withdrawn from the seat belt retractor; and a buckle by which the tongue is disengageably retained. In the event of an emergency, the withdrawal of the seat belt is inhibited by the seat belt retractor to restrain an occupant. With this configuration, the piston and elastic member can be integrally handled at assembly, allowing more easy and accurate assembling and manufacturing to be achieved.

### BRIEF DESCRIPTION OF THE DRAWINGS

FIG. 1 is a perspective view illustrating a seat belt apparatus provided with an example of an embodiment of a seat belt retractor according to the present invention;

FIG. 2A is a left side view of the seat belt retractor of the embodiment and FIG. 2B is a cross-sectional view taken along line IIB-IIB in FIG. 2A;

FIG. 3 is a view illustrating a pretensioner of the seat belt retractor in FIG. 2A, from which a cover, balls, and a spring means are removed;

FIG. 4 is a view illustrating a part of the inside of a pipe of the pretensioner of the embodiment;

FIG. 5 is a view illustrating the inner side of the cover of the pretensioner of the embodiment;

FIGS. 6A to 6C are explanatory views illustrating the operation of the pretensioner, in which FIG. 6A illustrates a non-operation state, FIG. 6B illustrates a state immediately after the start of operation, and FIG. 6C illustrates an operation end state;

FIG. 7 is a cross-sectional view illustrating a first embodiment of the piston of the pretensioner of the embodiment;

FIGS. 8A to 8C are partial cross-sectional views illustrating a procedure of installing the piston of the first embodiment and a gas generator in the pipe of the pretensioner of the embodiment;

FIG. 9 is a cross-sectional view illustrating a second embodiment of the piston of the pretensioner of the embodiment;

FIG. 10 is a cross-sectional view illustrating a third embodiment of the piston of the pretensioner of the embodiment;

FIG. 11 is a cross-sectional view illustrating a fourth embodiment of the piston of the pretensioner of the embodiment;

FIG. 12 is a cross-sectional view illustrating a fifth embodiment of the piston of the pretensioner of the embodiment; and

FIG. 13 is a cross-sectional view illustrating a sixth embodiment of the piston of the pretensioner of the embodiment.

### BEST MODE FOR CARRYING OUT THE INVENTION

Hereinafter, embodiments for practicing the present invention will be described using the accompanying drawings.

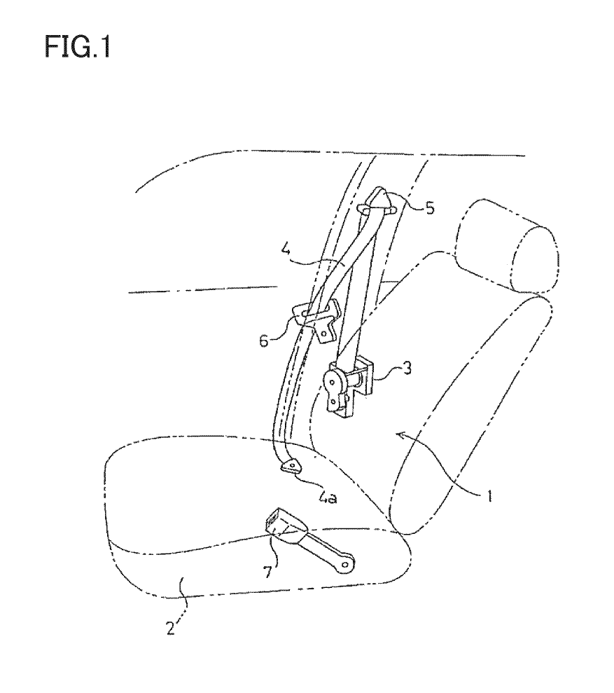

FIG. 1 is a view schematically illustrating a seat belt apparatus provided with an example of an embodiment of a seat belt retractor according to the present invention.

As illustrated in FIG. 1, a seat belt apparatus 1 of the embodiment is basically the same as a known three-point seat belt apparatus. In the drawing, reference numeral 1 denotes the seat belt apparatus, numeral 2 denotes a vehicle seat, numeral 3 denotes a seat belt retractor provided near the vehicle seat 2, numeral 4 denotes a seat belt that is withdrawn and retracted by the seat belt retractor 3 and has a belt anchor 4a provided at a leading end thereof and fixed to the floor of the vehicle body or the vehicle seat 2, numeral 5 denotes a guide anchor that guides the seat belt 4, which is withdrawn from the seat belt retractor 3, toward the shoulder of an occupant, numeral 6 denotes a tongue slidably supported by the seat belt 4 guided from the guide anchor 5, and numeral 7 denotes a buckle that is fixed to the floor of the vehicle body or the vehicle seat in a manner such that the tongue 6 is disengageably inserted in and engaged with the buckle 7. Operations of buckling and unbuckling the seat belt 4 in the seat belt apparatus 1 are also the same as those adopted in the known seat belt apparatus.

The seat belt retractor 3 of the embodiment is formed as a known emergency locking seat belt retractor (ELR) or a known automatic locking seat belt retractor (ALR). This seat belt retractor 3 includes a pretensioner and an energy absorbing (EA) mechanism.

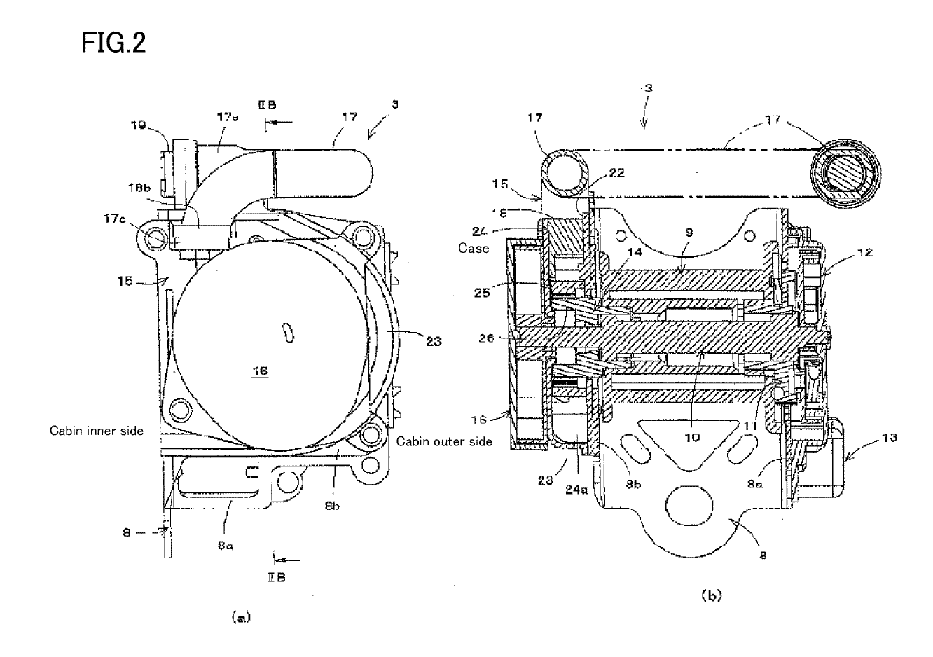

FIGS. 2A and 2B are views illustrating the seat belt retractor of the embodiment including the pretensioner and the EA mechanism.

As illustrated in FIGS. 2A and 2B, the seat belt retractor 3 includes a U-shaped frame 8 having opposite side walls 8a and 8b, a spool 9 that retracts the seat belt 4, a torsion bar 10 of the EA mechanism, a locking base 11 serving as the locking member of the present invention, a lock mechanism 12, a deceleration detecting mechanism 13, a cylindrical connecting member 14, a pretensioner 15 using a predetermined number of balls as drive transmission members, and a spring means 16 that always biases the spool 9 in a seat-belt retracting direction.

In a normal state in which the deceleration detecting mechanism 13 and the pretensioner 15 do not operate, when the seat belt 4 is withdrawn, the spool 9 is rotated in a seat-belt withdrawing direction, so that the seat belt 4 is withdrawn. Since the deceleration detecting mechanism 13 does not operate in this normal withdrawal of the seat belt 4, the lock mechanism 12 does not operate, and the spool 9 is rotated together with the connecting member 14, torsion bar 10, and locking base 11. Therefore, the seat belt 4 is withdrawn easily.

When the hand is released from the seat belt 4 after withdrawing the seat belt 4, the spool 9 is rotated in the seat-belt retracting direction by biasing force of the spring means 16 transmitted through the connecting member 14. Then, the spool 9 retracts the entire or almost entire of the withdrawn portion of the seat belt 4. During this normal retraction of the seat belt 4, the spool 9 is rotated together with the connecting member 14, torsion bar 10, and locking base 11. Therefore, the seat belt 4 is retracted easily.

If a certain deceleration to effect on the deceleration detecting mechanism 13 is applied to a traveling vehicle, the deceleration detecting mechanism 13 is responsive thereto, causing the lock mechanism 12 to operate. Then, an unillustrated pawl provided in the locking base 11 turns into engagement with unillustrated lock teeth formed on the side wall 8a. This locks the rotation of the locking base 11 in the seat-belt withdrawing direction. On the other hand, the seat belt 4 is almost withdrawn by the inertia of the occupant, and the spool 9 is almost rotated relative to the locking base 11 in the seat-belt withdrawing direction. As a result, the torsion bar 10 is twisted. The resistance due to torsional deformation of the torsion bar 10 suppresses the rotation of the spool 9 in the seat-belt withdrawing direction. In this way, the occupant is restrained by the seat belt 4. In this case, the kinetic energy of the occupant is partially absorbed by the torsional deformation of the torsion bar 10, and therefore, the force applied from the seat belt 4 to the occupant is limited.

The following describes the pretensioner 15 of the embodiment.

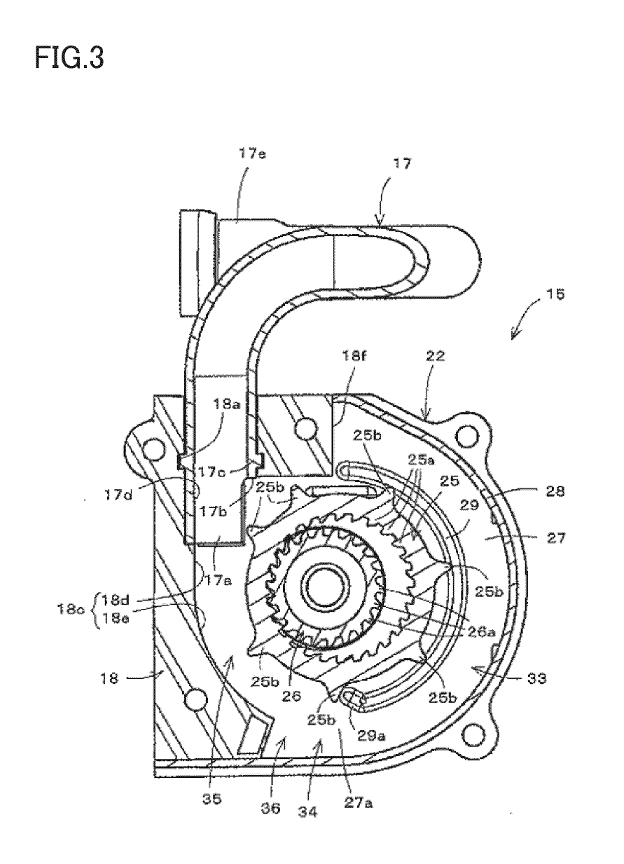

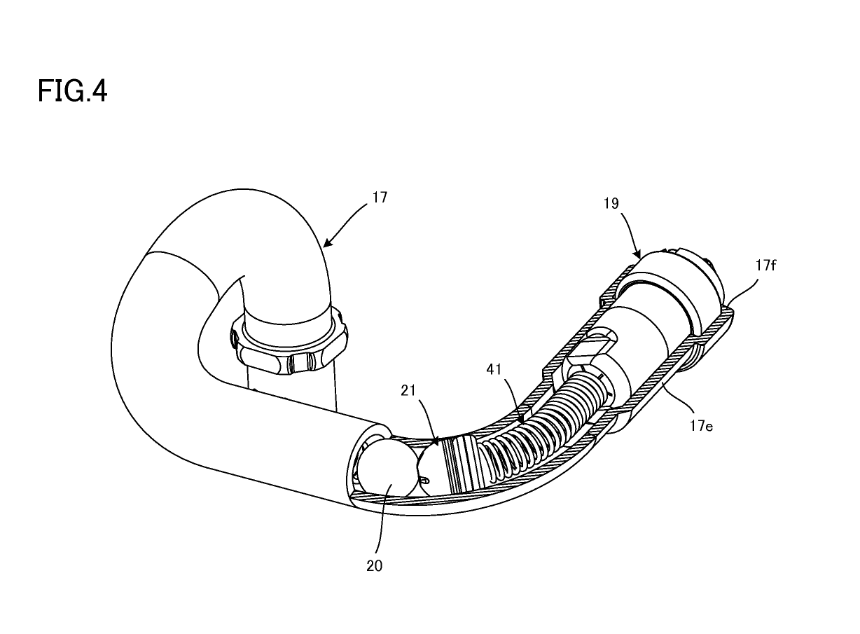

FIG. 3 is a view illustrating the pretensioner 15 of the seat belt retractor in FIG. 2A, from which a cover, the balls, and the spring means are removed, and FIG. 4 is a view illustrating apart of the inside of a pipe of the pretensioner of the embodiment.

As illustrated in FIGS. 3 and 4, the pretensioner 15 includes a pipe 17, and one end portion 17a of the pipe 17 is opened. In the end portion 17a, a cutout portion 17b extending from the open end of the pipe 17 in the axial direction of the pipe 17 and a mounting flange portion 17c are provided. The end portion 17a of the pipe 17 is attached to a guide member 18. In this case, the mounting flange portion 17c is fitted in a mounting groove 18a formed in the guide member 18 and is locked to a locking portion 18b (see FIG. 2A) formed in the guide member 18. Further, although not illustrated, in a state in which the end portion 17a of the pipe 17 is attached to the guide member 18 and the guide member 18 is attached to the side wall 8b of the frame through a case base 22, one part of the mounting flange portion 17c is locked in an upward orientation by a rectangular small aperture provided in the side wall 8b, and the other part of the mounting flange portion 17c is locked in an upward orientation by the locking portion 18b of the guide member 18. This prevents the pipe 17 from coming out of the guide member 18 in the upward direction.

The guide member 18 has a guide face 18c. This guide face 18c includes a linear guide face 18d and a guide face 18e that is provided in contact with the linear guide face 18d and shaped like a circular arc concentric or substantially concentric with the rotation axis of the spool 9. As illustrated in FIG. 3, in a state in which the end portion 17a of the pipe 17 is attached to the guide member 18, the linear guide face 18d is located on an extension line of an inner peripheral face 17d of the pipe 17 serving as a cross section taken along a plane in the axial direction passing through the radial center of the pipe 17.

As illustrated in FIG. 4, a gas generator 19 for generating reaction gas is provided in the other end portion 17e of the pipe 17. Further, a predetermined number of balls 20 serving as the force transmission members of the present invention and formed of metal such as iron or aluminum, and a piston 21 for pushing the balls 20 by receiving gas pressure from the gas generator 19 are movably provided in the pipe 17.

The pretensioner 15 includes the case base 22, and the case base 22 is attached to the side wall 8b. The guide member 18 is similarly attached to the side wall 8b of the frame 8 through the case base 22. Further, the case base 22 and guide member 18 are covered with a cover 23. The case base 22, guide member 18, and cover 23 define a case 24 of the pretensioner 15 having an inner space 24a.

As illustrated in FIGS. 2B and 3, in the inner space 24a of the case 24, a ring gear 25 is provided rotatably and movably to the right in FIG. 3 (FIG. 3 illustrates a state after the ring gear 25 is moved to the right). The ring gear 25 has a plurality of internal teeth 25a on the inner peripheral surface thereof.

A plurality of (seven in the illustrated example) levers 25b serving as the pressed portions of the present invention project from the outer peripheral surface of the ring gear 25. In a normal state in which the pretensioner 15 does not operate, the interval in the circumferential direction between the lever 25b that the first ball 20 first contacts and the lever 25b adjacent thereto in the clockwise direction is set such that a part of one ball 20 can be received therebetween. Further, another interval in the circumferential direction between two adjacent levers 25b is set such that two balls 20 in contact with each other can be received in order therebetween. The levers 25b of the ring gear 25 can enter the pipe 17 from the cutout portion 17b at the end portion 17a of the pipe 17.

An annular pinion 26 is attached to the connecting member 14 of the seat belt retractor 3 so as to be rotated together with the connecting member 14 (although not illustrated, the spool 9 and the connecting member 14 can be integrally formed and the pinion 26 can be formed integrally with the connecting member 14).

The pinion 26 has a plurality of external teeth 26a. The internal teeth 25a of the ring gear 25 can be meshed with the external teeth 26a of the pinion 26. During operation of the pretensioner 15, the balls 20 apply the pressing force of the ring gear 25 to the levers 25b that have entered the pipe 17 from the cutout portion 17b of the pipe 17, and apply, to the ring gear 25, force such that the ring gear 25 is moved straight toward the pinion 26.

In the pretensioner 15 of the embodiment, the pipe 17 is piped such that an end of the end portion 17a is located at the lowermost position in FIG. 3 in a state in which the pretensioner 15 is mounted in the vehicle body. In this case, the position of the end of the end portion 17a is somewhat higher than the rotation center of the pinion 26 (that is, the rotation center of the spool 9). With this, the balls 20 transmit the force to the levers 25b of the ring gear 25 almost in the tangential direction of the ring gear 25 and in the seat-belt retracting direction. As a result, the balls 20 most efficiently transmit the force to the ring gear 25.

In addition, the pipe 17 is bent at a substantially right angle above the frame 8, linearly and substantially horizontally extends toward the cabin outer side, is bent at a substantially right angle near a free end of the side wall 8b, linearly and substantially horizontally extends in the front-rear direction of the vehicle, is bent at a substantially right angle near the side wall 8a, and linearly and substantially horizontally extends toward the cabin inner side. Therefore, the gas generator 19 substantially horizontally extends toward the cabin inner side above a fixed end of the side wall 8a of the frame 8.

The case base 22 is provided with a case-base-side guide groove 27 that guides the balls 20. In this case, the case-base-side guide groove 27 is formed into a substantially circular arc that is substantially concentric with the center of the ring gear 25 in the state of FIG. 3 in which the ring gear 25 is moved to the right, allowing the internal teeth 25a thereof to be meshed with the external teeth 26a of the pinion 26. The case-base-side guide groove 27 is provided outside the ends of the levers 25b of the ring gear 25 located at the position in FIG. 3. Therefore, the levers 25b by no means enter the case-base-side guide groove 27. This case-base-side guide groove 27 is defined by a case-base outer peripheral guide wall 28 and a case-base inner peripheral guide wall 29 that form a pair. These outer and inner peripheral guide walls 28 and 29 are formed into a substantially circular arc that is substantially concentric with the rotation center of the pinion 26.

Further, a case-base-side groove guide portion 29a that guides the balls 20 to the case-base-side guide groove 27 is provided at an upstream end of the case-base inner peripheral guide wall 29 along which the balls 20 are moved. The case-base-side groove guide portion 29a is formed as an inclined surface that is inclined inward from the tangent to the arc at the upstream end of the case-base inner peripheral guide wall 29. In the case base 22, a case-base-side ball guide groove 27a that guides the balls 20 to the case-base-side guide groove 27 is formed by the case-base-side groove guide portion 29a.

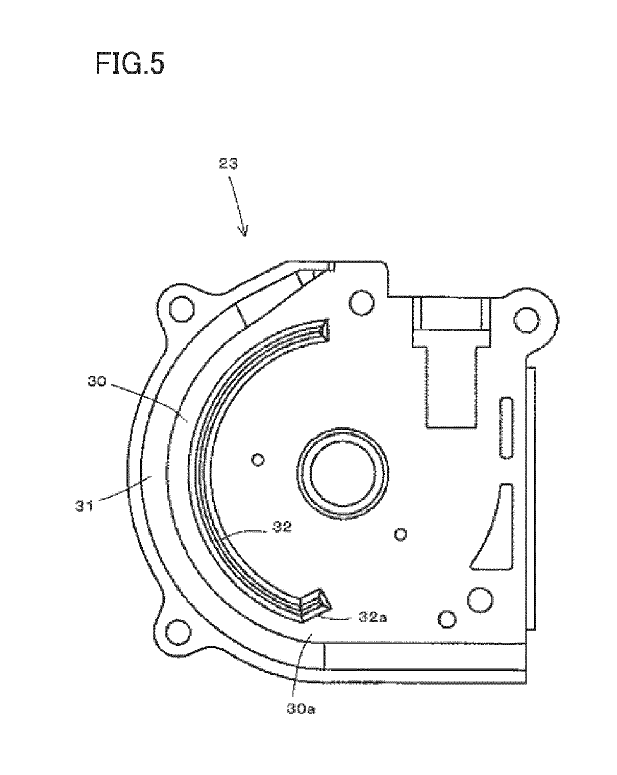

FIG. 5 is a view illustrating the inner side of the cover of the pretensioner of the embodiment.

As illustrated in FIG. 5, the cover 23 is provided with a cover-side guide groove 30 that guides the balls 20. The cover-side guide groove 30 is defined by a cover outer peripheral guide wall 31 and a cover inner peripheral guide wall 32 that form a pair. In this case, the cover outer peripheral guide wall 31 is formed into a circular arc that has almost the same diameter as that of the arc-shaped case-base outer peripheral guide wall 28 and concentric with the case-base outer peripheral guide wall 28, and the circumferential length of the cover outer peripheral guide wall 31 is set to be equal or substantially equal to the circumferential length of the case-base outer peripheral guide wall 28. Further, the cover inner peripheral guide wall 32 is formed into a circular arc that has almost the same diameter as that of the arc-shaped case-base inner peripheral guide wall 29 and concentric with the case-base inner peripheral guide wall 29, and the circumferential length of the cover inner peripheral guide wall 32 is set to be equal or substantially equal to the circumferential length of the case-base inner peripheral guide wall 29.

In addition, a cover-side groove guide portion 32a that guides the balls 20 to the cover-side guide groove 30 is provided at an upstream end of the cover inner peripheral guide wall 32 along which the balls 20 are moved. This cover-side groove guide portion 32a is formed as an inclined surface that is inclined inward from the tangent to the arc at the upstream end of the cover inner peripheral guide wall 32. In this case, the inclination angle of the cover-side groove guide portion 32a with respect to the tangent to the arc and the length of the cover-side groove guide portion 32a are set to be equal or substantially equal to the inclination angle of the case-base-side groove guide portion 29a with respect to the tangent to the arc and the length of the case-base-side groove guide portion 29a, respectively. In the cover 23, a cover-side ball guide groove 30a that guides the balls 20 to the cover-side guide groove 30 is formed by the cover-side groove guide portion 32a.

In a state in which the cover 23 is attached to and combined with the case base 22, the case-base outer peripheral guide wall 28 and the cover outer peripheral guide wall 31 are almost aligned, and the case-base inner peripheral guide wall 29 and the cover inner peripheral guide wall 32 are almost aligned, so that the case-base-side guide groove 27 and the cover-side guide groove 30 define an arc-shaped passage 33 through which the balls 20 are moved. Further, the case-base-side groove guide portion 29a and the cover-side ball guide groove 30a are almost aligned, so that the case-base-side groove guide portion 29a and the cover-side ball guide groove 30a define a guide passage 34 through which the balls 20 are guided to the above-described arc-shaped passage 33 after the balls 20 come out of the pipe 17 and rotate the ring gear 25.

In the pretensioner 15 of the embodiment, the arc-shaped passage 33, the guide passage 34, and a guide passage 35 formed between the guide face 18c of the guide member 18 and the ring gear 25 define a substantially arc-shaped ball receiving chamber along the outer periphery of the ring gear 25. In this case, the levers 25b of the ring gear 25 do not enter a portion of the ball receiving chamber defined by the arc-shaped passage 33 and the guide passage 34. As illustrated in FIG. 3, the guide member 18 has a stopper portion 18f, and the stopper portion 18f almost closes a downstream end of the arc-shaped passage 33. Further, a small ball receiving portion 36 that receives the balls 20 is provided below a portion of the guide passage 35 adjacent to the guide passage 34 in a manner such that the levers 25b of the ring gear 25 do not contact the balls 20. All of the arc-shaped passage 33, the guide passage 34, the guide passage 35, and the ball receiving portion 36 are provided in the case 24.

Operation of the seat belt retractor 3 of the embodiment having such a configuration will be described.

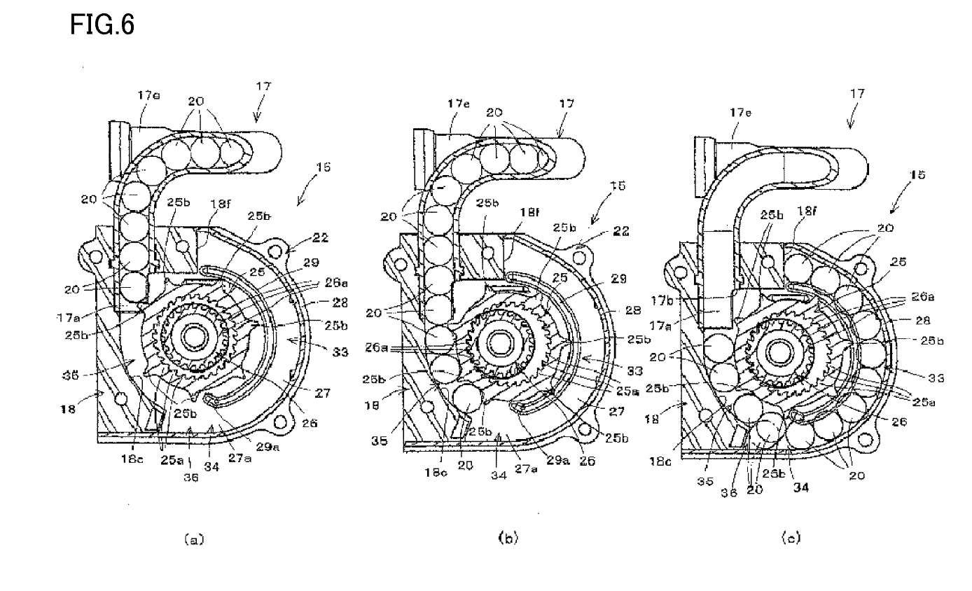

FIGS. 6A to 6C are explanatory views illustrating the operation of the pretensioner, in which FIG. 6A illustrates a non-operation state, FIG. 6B illustrates a state immediately after the start of operation, and FIG. 6C illustrates an operation end state.

As illustrated in FIG. 6A, when the pretensioner 15 is in a non-operation state, the ring gear 25 is held substantially concentric with the pinion 26 so as not to be rotated and moved to the right. Therefore, the ring gear 25 is held in a state in which the internal teeth 25a are not meshed with the external teeth 26a of the pinion 26. Further, the first ball 20 is held in contact with one lever 25b. In this case, the first ball 20 can enter a small gap between the adjacent levers 25b. Further, the adjacent balls 20 of the first ball 20 and subsequent balls 20 are sequentially in contact with each other in the pipe 17. At this time, the gas generator 19 does not generate gas, and the balls 20 do not substantially press the levers 25b.

In the above-described event of the emergency, the deceleration detecting mechanism 13 and the lock mechanism 12 operate to lock the rotation of the locking base 11 in the seat-belt withdrawing direction, and the gas generator 19 operates to generate gas, as conventionally. Since the generated gas pushes the piston 21, the piston 21 applies a great push force to the ball 20 in contact therewith. Then, together with the balls 20, the piston 21 is moved forward to the one end portion 17a of the pipe 17 along the interior of the pipe 17 while pushing the balls 20. At this time, since a head portion 21d of the piston 21 is formed into a substantially hemispherical shape, and the balls 20 function as the force transmission members, the piston 21 is moved comparatively smoothly and quickly in the interior of the bent pipe 17.

The push force of the piston 21 is transmitted from above to bottom through the balls 20 to the first ball 20 in contact with the ring gear 25. Then, the first ball 20 moves the ring gear 25 to the right and rotates the ring gear 25 counterclockwise in FIG. 2A by the push force. Then, as illustrated in FIG. 6B, the internal teeth 25a of the ring gear 25 are meshed with the external teeth 26a of the pinion 26, and the pinion 26 starts rotating in the same direction as that of the ring gear 25. In response to the start of rotation of the pinion 26, the spool 9 starts rotating in the seat-belt retracting direction through the pinion 26 and the connecting member 14, and retraction of the seat belt 4 worn by the occupant starts. In this case, the ring gear 25 is pushed down by the balls 20, whereby the ring gear 25 is pushed below the spool 9 through the pinion 26. In this case, since the spool 9 is pulled upward by the seat belt 4, the rotational resistance provided when the ring gear 25 rotates the pinion 26 and the spool 9 is relatively low.

When the first ball 20 is received in the small gap between the levers 25b and the next second ball 20 comes into contact with the lever 25b adjacent clockwise to the lever 25b that was in contact with the first ball 20, the pressing force applied to the lever 25b through the second ball 20 further rotates both the ring gear 25 and the pinion 26 counterclockwise. In this case, the pressing force applied from the first ball 20 to the lever 25b is substantially lost. Two balls, that is, the second and third balls 20 are received between the lever 25b that was in contact with the second ball 20 and the next lever 25b adjacent to that lever 25b in the clockwise direction while pressing the lever 25b. Further, when the fourth ball 20 next to the third ball 20 comes into contact with the next lever 25b, the pressing force applied to the next lever 25b through the fourth ball 20 further rotates both the ring gear 25 and the pinion 26 counterclockwise. In this case, the pressing force applied from the second and third balls 20 to the lever 25b is substantially lost. Subsequently, the balls 20 sequentially press the levers 25b, so that the ring gear 25 and the pinion 26 are rotated counterclockwise. That is, the spool 9 is rotated in the seat-belt retracting direction, and the seat belt 4 is wound around the spool 9.

As illustrated in FIG. 6B, the first ball 20 whose pressing force to the lever 25b is substantially lost is moved along the guide passage 35 by the lever 25b with the rotation of the ring gear 25. As illustrated in FIG. 6C, the first ball 20 enters the guide passage 34, is separated from the lever 25b, and moved into the arc-shaped passage 33 along the guide passage 34. Similarly, the second and subsequent balls 20 whose pressing forces to the levers 25b are substantially lost are sequentially moved to the arc-shaped passage 33 along the guide passage 34. While being moved through the guide passage 34 and the arc-shaped passage 33, the balls 20 do not contact the levers 25b of the ring gear 25. In other words, the rotation of the ring gear 25 is not influenced by the balls 20 located in the guide passage 34 and the arc-shaped passage 33, and the pressing forces from the balls 20 to the levers 25b are efficiently utilized for rotating the ring gear 25.

Part of the gas generated by the gas generator 19 flows to the ball 20 side of the piston 21 through an exhaust hole 21e and exhaust grooves 21f of the piston 21. This suppresses an excessive increase in pressure at the gas generator 19 side of the piston 21.

That is, the gas in the pipe 17 on the gas generator 19 side can flow toward the ball 20 side of the piston 21, whereby the resistance of the gas to the return of the piston 21 can be suppressed. This allows more smooth movement of the piston 21, and hence allows more smooth rotation of the ring gear 25 in the seat-belt withdrawing direction. As a result, the EA operation can be even more effectively performed.

When the first ball 20 comes into contact with the stopper portion 18f or when the tension of the seat belt 4 for rotating the spool 9 in the seat-belt withdrawing direction becomes equal to the force of the balls 20 for rotating the spool 9 in the seat-belt retracting direction, the movement of the balls 20 stops, so that the rotations of the ring gear 25 and pinion 26 stop and the operation of the pretensioner 15 stops. Therefore, winding of the seat belt 4 around the spool 9 by the operation of the pretensioner 15 is finished. As a result, the occupant is more firmly restrained by the seat belt 4.

Subsequently, the seat belt 4 is almost withdrawn by the inertia of the occupant, and the spool 9 is almost rotated in the seat-belt withdrawing direction. In this state, since the rotation of the locking base 11 in the seat-belt withdrawing direction is locked, the torsion bar 10 is subjected to torsional deformation. Since the spool 9 is rotated in the seat-belt withdrawing direction by the torsional deformation of the torsion bar 10, the force applied from the seat belt 4 to the occupant is limited. That is, the torsion bar 10 performs EA operation.

During EA operation of the torsion bar 10, the spool 9 is rotated in the seat-belt withdrawing direction, and therefore, the ring gear 25 is rotated in the same direction. Then, in FIG. 6C, three balls 20 at the terminal end are returned toward the pipe 17 by the corresponding levers 25b of the ring gear 25 with the rotation of the ring gear 25. However, the balls 20 from the fourth ball 20 from the terminal end to the ball 20 at the leading end (first ball 20 side) do not touch the levers 25b of the ring gear 25, and therefore, are not returned to the pipe 17. In this case, the fourth ball 20 from the terminal end is received in the ball receiving portion 36, as denoted by a two-dot chain line in FIG. 6C. The balls 20 closer to the leading end than the fourth ball 20 are unable to be moved to the pipe 17 because the fifth ball 20 adjacent to the fourth ball 20 and closer to the leading end comes into contact with the fourth ball 20, whereby backward movement of these balls 20 is prevented. That is, during the EA operation, some of the balls 20, that is, the three balls 20 at the terminal end are returned by the ring gear 25. Therefore, the influence of the balls 20 on the rotation of the ring gear 25 in the seat-belt withdrawing direction is suppressed. Since the influence of the balls 20 on the rotation of the ring gear 25 in the seat-belt withdrawing direction is thus suppressed during EA operation of the torsion bar 10, the ring gear 25 is rotated more smoothly. As a result, the EA operation is effectively performed by the torsion bar 10.

Although not illustrated in FIG. 6C, the piston 21 is also returned toward the gas generator 19 by the balls 20 that are moved toward the pipe 17. While the pressure in the pipe 17 on the gas generator 19 side of the piston 21 is increased by this movement of the piston 21, the gas in the pipe 17 on the gas generator 19 side flows to the ball 20 side of the piston 21 through the exhaust hole 21e and exhaust grooves 21f of the piston 21. This suppresses the resistance of the gas to the movement of the piston 21. Since this allows more smooth movement of the piston 21, the ring gear 25 is also more smoothly rotated in the seat-belt withdrawing direction. Therefore, the EA operation of the torsion bar 10 becomes more effective.

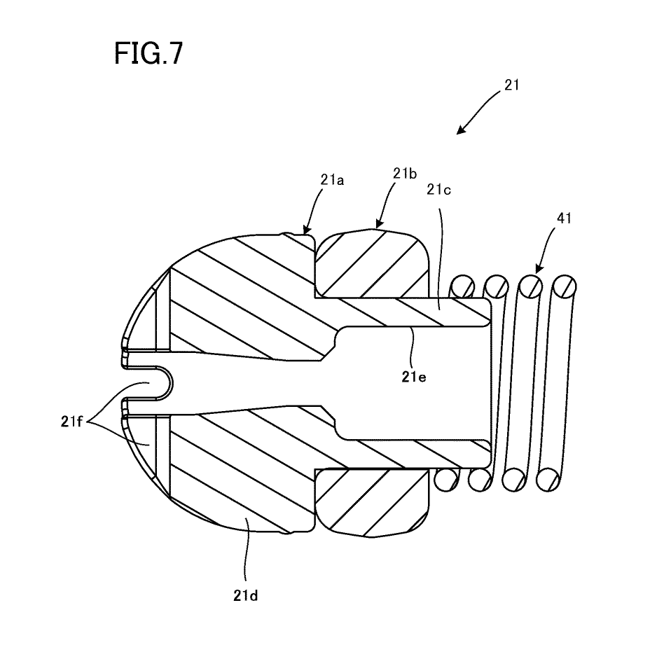

FIG. 7 is a cross-sectional view illustrating a first embodiment of the piston of the pretensioner of the embodiment.

The piston 21 has a piston body 21a made of metal similarly to the balls 20 and a piston ring 21b made of non-metal material such as silicone or resin.

As illustrated in FIG. 7, the piston body 21a has a columnar shaft portion 21c positioned at the gas generator 19 side and a substantially hemispherical (i.e., substantially spherical) head portion 21d positioned at the balls 20 side. In this case, the center side of the substantially hemispherical head portion 21d in the radial direction protrudes toward the balls 20 side from the outer peripheral portion. The shaft portion 21c and the head portion 21d are integrally formed, and an exhaust hole 21e is drilled so as to penetrate the shaft portion 21c and the head portion 21d in the axial direction. Further, four cross-shaped exhaust grooves 21f are formed in the head portion 21d so as to communicate with the exhaust hole 21e. The exhaust grooves 21f each have a fixed width.

The presence of the exhaust grooves 21f prevents the exhaust hole 21e from being closed by the ball 20 with the head portion 21d of the piston body 21a being in contact with the ball 20. Therefore, even in a state in which the head portion 21d of the piston 21 is in contact with the ball 20, the gas generator 19 side and balls 20 side of the piston 21 always communicate with each other through the exhaust hole 21e and the exhaust grooves 21f. The exhaust hole 21e and exhaust groove 21f define an exhaust passage along which the gas flows.

The piston ring 21b is formed into a cylindrical shape and is fitted to the shaft portion 21c of the piston body 21a. The thus configured piston ring 21b is provided so as to be able to air-tightly or almost air-tightly seal between the outer peripheral surface of the shaft portion 21c and the inner peripheral surface of the pipe 17 and to be slidable with respect to the inner peripheral surface of the pipe 17.

The gas generated by the gas generator 19 pushes the piston 21 to the left in FIG. 4, so that the piston 21 pushes the balls 20 in the same direction. Further, the gas from the gas generator 19 can be supplied by a prescribed amount from the gas generator 19 side to balls 20 side of piston 21 through the exhaust hole 21e and the exhaust grooves 21f. In this case, even in a state in which the head portion 21d of the piston 21 is in contact with the ball 20, part of the gas can flow to the ball 20 side of the piston 21 through the exhaust grooves 21f.

The exhaust grooves 21f may be formed such that the width of the center portion thereof is the largest and the width becomes gradually smaller from the center toward the leading end. Further, the number of the exhaust grooves 21f of the piston 21 is not limited to four, but may be arbitrary. When the plurality of exhaust grooves 21f are formed, the grooves 21f are preferably arranged at equal intervals in the circumferential direction.

A spring 41 is attached to the outer periphery of the shaft portion 21c of the piston 21. As illustrated in FIG. 7, one end of the spring 41 is fitted to the piston 21 so as to fasten the outer periphery of the shaft portion 21c. The other end of the spring 41 abuts against the gas generator 19. Therefore, the piston 21 is pressed against the ball 20 by the biasing force of the spring 41.

In the pretensioner of the embodiment, one end of the spring 41 is attached to the piston 21, so that the spring 41 can be prevented from coming out to the outside of the pipe 17, allowing easy and accurate assembling and manufacturing to be achieved.

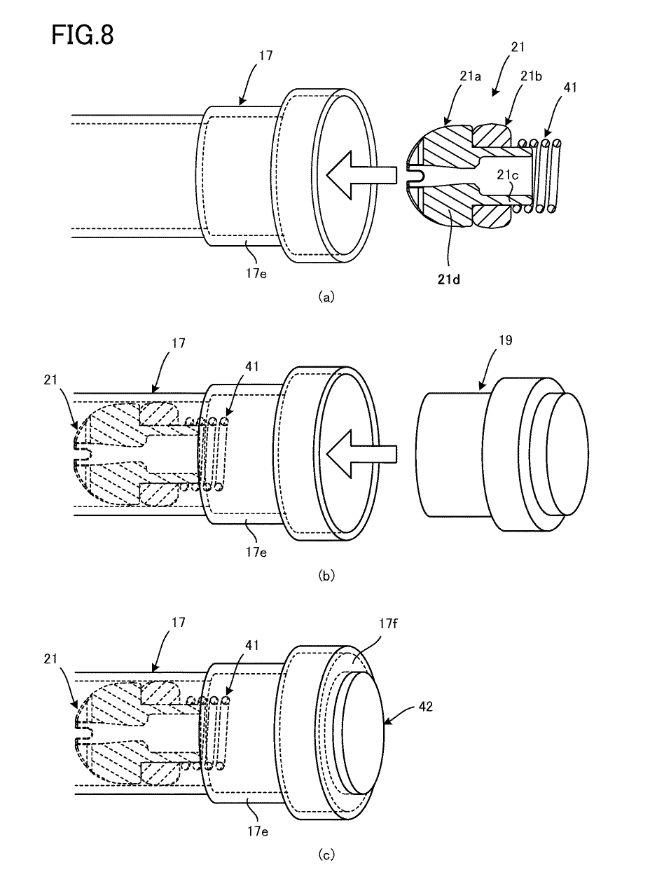

FIGS. 8A to 8C are partial cross-sectional views illustrating a procedure of installing the piston of the first embodiment and the gas generator in the pipe of the pretensioner of the embodiment.

As denoted by the arrow of FIG. 8A, the piston 21 is accommodated in the pipe 17. The piston 21 is inserted into the piston 21 from the head portion 21d side. At this time, the piston ring 21b and the spring 41 are fitted to the outer periphery of the shaft portion 21c and therefore hardly come out of the piston 21.

After the piston 21 is accommodated in the pipe 17, the gas generator 19 is accommodated in the pipe 17 as illustrated in FIG. 8B. At this time, the gas generator 19 is pushed against the biasing force of the spring 41 so as to contract the spring 41.

After the gas generator 19 is accommodated in the pipe 17, a leading end 17f of the one end portion 17a of the pipe 17 is caulked to the inner peripheral side as illustrated in FIG. 8C, whereby installation of the piston 21 and gas generator 19 in the pipe 17 is completed.

In the pretensioner of the embodiment, the piston and the gas generator are installed in the pipe in the procedure as described above, so that the spring 41 is prevented from coming out to the outside of the pipe 17, allowing easy and accurate assembling and manufacturing to be achieved.

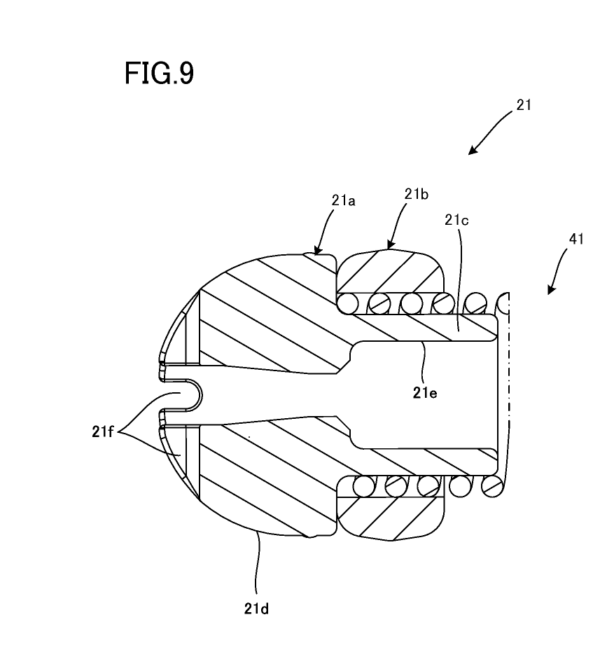

FIG. 9 is a cross-sectional view illustrating a second embodiment of the piston of the pretensioner of the embodiment.

In the second embodiment, the spring 41 is attached to the outer periphery of the shaft portion 21c of the piston 21, and the piston ring 21b is attached to the spring 41 from outside the spring 41. One end of the spring 41 is fitted to the piston 21 so as to fasten the outer periphery of the shaft portion 21c, and the piston ring 21b is fitted to the outside of the one end of the spring 41 so as to fasten the one end of the spring 41. The other end of the spring 41 abuts against the gas generator 19. Therefore, the piston 21 is pressed against the ball 20 by the biasing force of the spring 41.

In the pretensioner of the second embodiment, the spring 41 is attached to the outer periphery of the shaft portion 21c of the piston 21, and the piston ring 21b is attached to the one end of the spring 41 from outside the spring 41. Therefore, the fastening force of the spring 41 and fastening force of the piston ring 21b act on the shaft portion 21c of the piston 21, so that the spring 41 is attached to the piston 21 more firmly. That is, the spring 41 can be prevented from coming out to the outside of the pipe 17, allowing easy and accurate assembling and manufacturing to be achieved.

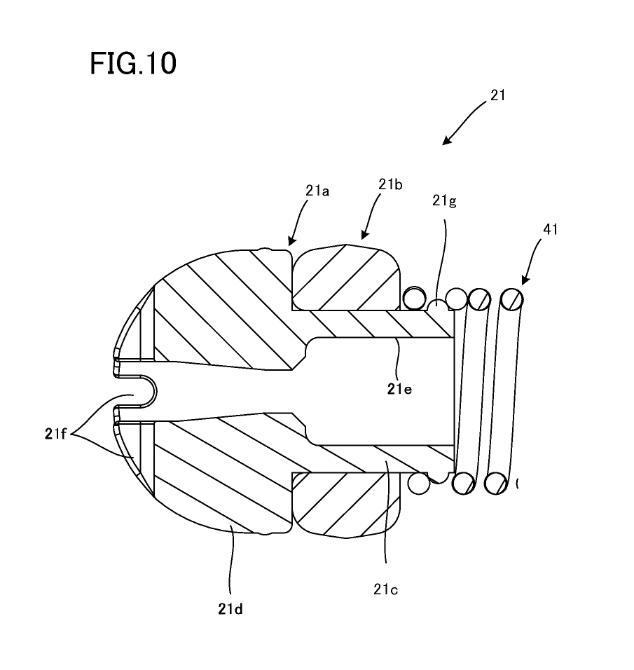

FIG. 10 is a cross-sectional view illustrating a third embodiment of the piston of the pretensioner of the embodiment.

In the piston 21 according to the third embodiment, an annular projection 21g is formed on the outer periphery of the shaft portion 21c. When the spring 41 is attached to the outer periphery of the shaft portion 21c of the piston 21, the spring 41 is hooked on the projection 21g, whereby the spring 41 is retained to the piston 21. The other end of the spring 41 abuts against the gas generator 19. Therefore, the piston 21 is pressed against the ball 20 by the biasing force of the spring 41.

In the pretensioner of the third embodiment, when the spring 41 is attached to the outer periphery of the shaft portion 21c of the piston 21, the spring 41 is hooked on the projection 21g. Therefore, the fastening force of the spring 41 acts on the shaft portion 21c of the piston 21, and the spring 41 is hooked on the annular projection 21g, so that the spring 41 is attached to the piston 21 more firmly. Thus, the spring 41 can be prevented from coming out to the outside of the pipe 17, allowing easy and accurate assembling and manufacturing to be achieved.

The projection 21g is formed annularly on the outer periphery of the shaft portion 21c in the third embodiment; however, the projection 21g need not be formed annularly and at least one projection 21g may be formed in an arbitrary shape at a predetermined position on the outer periphery of the shaft portion 21c so as to allow the spring 41 to be hooked thereon.

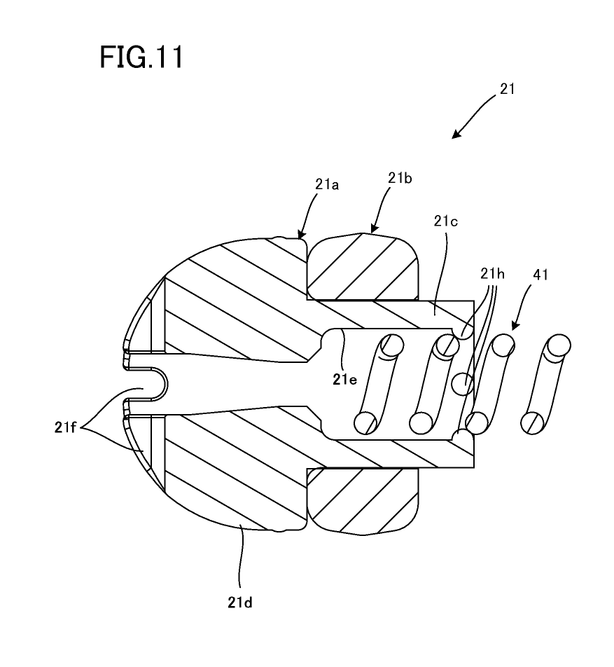

FIG. 11 is a cross-sectional view illustrating a fourth embodiment of the piston of the pretensioner of the embodiment.

In the piston 21 according to the fourth embodiment, a plurality of projections 21h are formed on the inner periphery of the shaft portion 21c at predetermined intervals. When the spring 41 is attached to the inner periphery of the shaft portion 21c of the piston 21, the spring 41 is hooked on the projections 21h, whereby the spring 41 is retained to the piston 21. The other end of the spring 41 abuts against the gas generator 19. Therefore, the piston 21 is pressed against the ball 20 by the biasing force of the spring 41.

In the pretensioner of the fourth embodiment, when the spring 41 is attached to the inner periphery of the shaft portion 21c of the piston 21, the spring 41 is hooked on the projections 21h. Therefore, the expanding force of the spring 41 acts on the shaft portion 21c of the piston 21, and the spring 41 is hooked on the annular projection 21h, so that the spring 41 is attached to the piston 21 more firmly. Thus, the spring 41 can be prevented from coming out to the outside of the pipe 17, allowing easy and accurate assembling and manufacturing to be achieved.

The projections 21h are formed on the inner periphery of the shaft portion 21c at predetermined intervals in the fourth embodiment; however, it suffices if at least one projection 21h is formed at a predetermined position on the inner periphery of the shaft portion 21c so as to allow the spring 41 to be hooked thereon. Alternatively, the projection 21h may be formed annularly on the inner periphery of the shaft portion 21c.

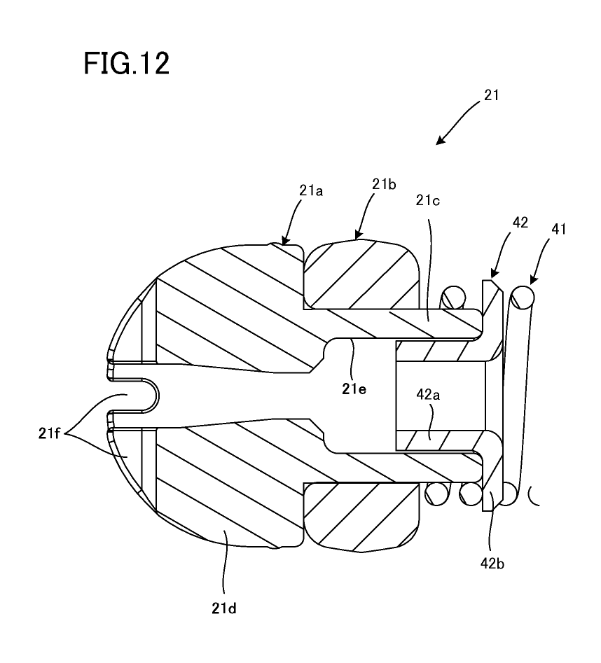

FIG. 12 is a cross-sectional view illustrating a fifth embodiment of the piston of the pretensioner of the embodiment.

In the fifth embodiment, the piston 21 has a spring hooking member 42 for attaching the spring 41 to the piston 21. The spring hooking member 42 has a tubular portion 42a and a flange portion 42b at least a part of which protrudes from one end of the tubular portion 42a to the outer peripheral side thereof. The tubular portion 42a of the spring hooking member 42 is fitted in and fixed inside the shaft portion 21c of the piston 21, and the spring 41 is hooked on the flange portion 42b of the spring hooking member 42, whereby the spring 41 is fixed to the piston 21. The other end of the spring 41 abuts against the gas generator 19, and the piston 21 is hence pressed against the ball 20 by the biasing force of the spring 41.

As described above, in the pretensioner of the fifth embodiment, the tubular portion 42a of the spring hooking member 42 is fitted in and fixed inside the shaft portion 21c of the piston 21, and the spring 41 is hooked on the flange portion 42b of the spring hooking member 42 when being attached to the outer periphery of the shaft portion 21c. Therefore, the fastening force of the spring 41 acts on the shaft portion 21c of the piston 21, and the spring 41 is hooked on the flange portion 42b, so that the spring 41 is attached to the piston 21 more firmly. Thus, the spring 41 can be prevented from coming out to the outside of the pipe 17, allowing easy and accurate assembling and manufacturing to be achieved.

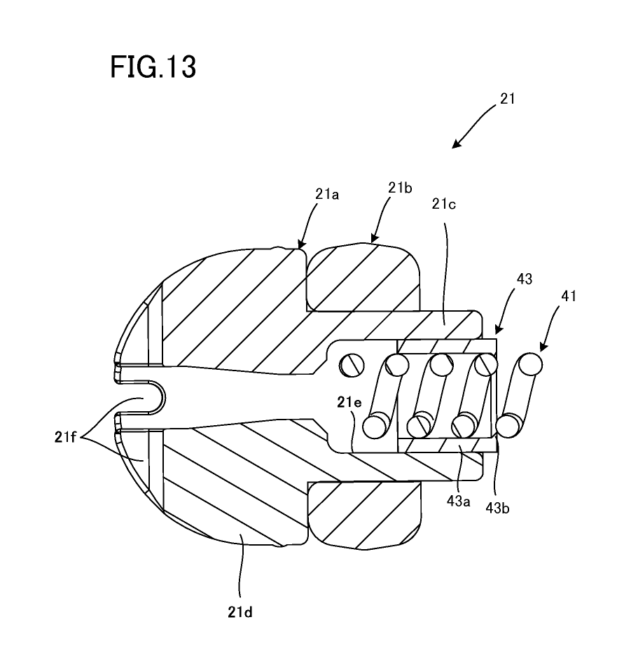

FIG. 13 is a cross-sectional view illustrating a sixth embodiment of the piston of the pretensioner of the embodiment.

In the sixth embodiment, the piston 21 has a spring hooking member 43 for attaching the spring 41 to the piston 21. The spring hooking member 43 has a tubular portion 43a and a flange portion 43b at least a part of which protrudes from one end of the tubular portion 43a to the inner peripheral side thereof. The tubular portion 43a of the spring hooking member 43 is fitted in and fixed inside the shaft portion 21c of the piston 21, and the spring 41 is hooked on the flange portion 43b of the spring hooking member 43, whereby the spring 41 is fixed to the piston 21. The other end of the spring 41 abuts against the gas generator 19 and the piston 21 is hence pressed against the ball 20 by the biasing force of the spring 41.

As described above, in the pretensioner of the sixth embodiment, the tubular portion 43a of the spring hooking member 43 is fitted in and fixed inside the shaft portion 21c of the piston 21, and the spring 41 is hooked on the flange portion 43b of the spring hooking member 43 when being attached to the inner periphery of the shaft portion 21c. Therefore, the expanding force of the spring 41 acts on the shaft portion 21c of the piston 21, and the spring 41 is hooked on the flange portion 43b, so that the spring 41 is attached to the piston 21 more firmly. Thus, the spring 41 can be prevented from coming out to the outside of the pipe 17, allowing easy and accurate assembling and manufacturing to be achieved.

The pretensioner 15 of the embodiment has at least the gas generator 19 for generating gas in the event of an emergency, the case 24, the pipe 17 mounted to the case 24, the predetermined number of balls 20 that are movably provided in the pipe 17 and moved by receiving gas pressure to transmit force for rotating the spool 9 in the seat-belt retracting direction, the piston 21 that is movably provided in the pipe 17 and moved by receiving gas pressure to push the balls 20, the ring gear 25 that is at least rotatably provided in the case 24, has, on the outer periphery thereof, the plurality of levers 25b pressed by the balls 20, and rotates the spool by the pressing force, and the spring 41 attached to the gas generator 19 side of the piston 21. With this configuration, the piston 21 and the spring 41 can be integrally handled at assembly, allowing easy and accurate assembling and manufacturing to be achieved.

Further, according to the pretensioner 15 of the embodiment, the piston 21 has the piston body 21a and the piston ring 21b fitted to the piston body 21a. The piston body 21a has the shaft portion 21c formed at the gas generator 19 side, and the spring 41 is attached to the shaft portion 21c, allowing more easy and accurate assembling and manufacturing to be achieved, which in turn achieves accurate operation.

Further, according to the pretensioner 15 of the embodiment, the piston body 21a has the exhaust passages 21e and 21f penetrating the piston body 21a from the balls 20 side to the gas generator 19 side. Thus, gas in the pipe 17 at the gas generator 19 side can flow to the balls 20 side of the piston 21, allowing further smooth movement of the piston 21.

Further, according to the pretensioner 15 of the embodiment, the shaft portion 21c has the projection 21g or 21h on which the spring 41 is hooked. Thus, the spring 41 can be hooked on the projection 21g or 21h, allowing more easy and accurate assembling and manufacturing to be achieved.

Further, according to the pretensioner 15 of the embodiment, the piston 21 has the hooking member 42 or 43 on which the spring 41 is hooked. The hooking member 42 or 43 has the tubular portion 42a or 43a fitted to the shaft portion 21c and the flange portion 42b or 43b protruding from one end of the tubular portion 42a or 43a. Thus, the spring 41 can be hooked on the hooking member 42 or 43, allowing more easy and accurate assembling and manufacturing to be achieved.

Further, the seat belt retractor 3 of the embodiment has at least the seat belt 4, the spool 9 that retracts the seat belt 4, the locking base 11 that is rotated together with the spool 9 in a normal state and inhibited from being rotated in a seat-belt withdrawing direction in the event of an emergency so as to produce a relative rotation with respect to the spool 9, the lock mechanism 12 that locks the rotation of the locking base 11 in the seat-belt withdrawing direction in the event of the emergency, an energy absorption mechanism 10 that is provided between the spool 9 and the locking base 11 and limits a load applied to the seat belt 4 during the relative rotation between the spool 9 and the locking base 11, and the pretensioner 15 that operates in the event of the emergency so as to rotate the spool 9 in the seat-belt retracting direction. With this configuration, the piston 21 and the spring 41 of the pretensioner 15 can be integrally handled at assembly, allowing easy and accurate assembling and manufacturing to be achieved.

Further, the seat belt apparatus 1 of the embodiment has at least the seat belt retractor 3 that retracts the seat belt 4, tongue 6 slidably supported by the seat belt 4 withdrawn from the seat belt retractor 3, and a buckle 7 by which the tongue 6 is disengageably retained. In the event of an emergency, the withdrawal of the seat belt 4 is inhibited by the seat belt retractor 3 to restrain an occupant. Further, the piston 21 and the spring 41 can be integrally handled at assembly, allowing easy and accurate assembling and manufacturing to be achieved.

### INDUSTRIAL APPLICABILITY

The seat belt retractor and the seat belt apparatus of the present invention can be suitably used in a seat belt retractor including a pretensioner using a plurality of balls as a force transmission member and an EA mechanism, and a vehicle seat belt apparatus including this seat belt retractor.

### REFERENCE SIGNS LIST

1: Seat belt apparatus
3: Seat belt retractor
4: Seat belt
6: Tongue
7: Buckle
8: Frame
9: Spool
10: Torsion bar (EA mechanism)
11: Locking base (locking mechanism)
12: Lock mechanism
13: Deceleration detecting mechanism
14: Connecting member
15: Pretensioner
17: Pipe
18: Guide member
18b: Locking portion
18c: Guide face
19: Gas generator
20: Ball (drive transmission member)
21: Piston
21a: Piston body
21b: Piston ring
21c: Shaft portion
21d: Head portion
21e: Exhaust hole (exhaust passage)
21f: Exhaust groove (exhaust passage)
21g, 21h: Projection
22: Case base
23: Cover
24: Case
25: Ring gear
25a: Internal teeth
25b: Lever (pressed portion)
26: Pinion
26a: External teeth
27: Case-base-side guide groove
27a: Case-base-side ball guide groove
28: Case-base outer peripheral guide wall
29: Case-base inner peripheral guide wall
29a: Case-base-side groove guide portion
30: Cover-side guide groove
30a: Cover-side ball guide groove
31: Cover outer peripheral guide wall
32: Cover inner peripheral guide wall
32a: Cover-side groove guide portion
33: Arc-shaped passage
34: Guide passage
35: Guide passage
36: Ball receiving portion
41: Spring (elastic member)
42, 43: Hooking member
42a, 43a: Tubular portion
42a, 43a: Flange portion

1. A pretensioner characterized by comprising:
a gas generator that generates gas in the event of an emergency;
a case;
a pipe mounted to the case;
a predetermined number of drive transmission members that are movably provided in the pipe and moved by receiving a pressure of the gas to transmit force for rotating a spool in a seat-belt retracting direction;
a piston that is movably provided in the pipe and moved by receiving a pressure of the gas to push the drive transmission members;
a ring gear that is at least rotatably provided in the case, has, on the outer periphery thereof, a plurality of pressed portions pressed by the drive transmission members, and rotates the spool by the pressing force; and
an elastic member attached to the gas generator side of the piston.

2. The pretensioner according to claim 1, characterized in that
the piston has a piston body and a piston ring fitted to the piston body,
the piston body has a shaft portion formed at the gas generator side thereof, and
the elastic member is attached to the shaft portion.

3. The pretensioner according to claim 2, characterized in that
the piston body has an exhaust passage penetrating the piston body from the drive transmission member side to the gas generator side.

4. The pretensioner according to claim 2, characterized in that
the shaft portion has a projection on which the elastic member is hooked.

5. The pretensioner according to claim 2, characterized in that
the piston has a hooking member on which the elastic member is hooked, and
the hooking member has a tubular portion fitted to the shaft portion and a flange portion at least a part of which protrudes from one end of the tubular portion.

6. A seat belt retractor characterized by comprising:
a seat belt;
a spool that retracts the seat belt;
a locking member that is rotated together with the spool in a normal state and inhibited from being rotated in a seat-belt withdrawing direction in the event of an emergency so as to produce relative rotation with respect to the spool;
a lock mechanism that locks the rotation of the locking member in the seat-belt withdrawing direction in the event of the emergency;
an energy absorption mechanism that is provided between the spool and the locking member and limits a load applied to the seat belt during the relative rotation between the spool and the locking member; and
the pretensioner as claimed in claim 1 that operates in the event of the emergency so as to rotate the spool in the seat-belt retracting direction.

7. A seat belt apparatus characterized by comprising:
a seat belt retractor as claimed in claim 1 that retracts the seat belt;
a tongue slidably supported by the seat belt withdrawn from the seat belt retractor; and
a buckle by which the tongue is disengageably retained, wherein,
in the event of an emergency, the withdrawal of the seat belt is inhibited by the seat belt retractor to restrain an occupant.
